(19) United States
(12) Patent Application Publication
(10) Pub. No.: US 2006/0185483 A1
(43) Pub. Date: Aug. 24, 2006

(54) Method for cross-cutting a printing material web, and cutting device

(75) Inventors: Klaus Liepert, Westendorf (DE); Georg Schmid, Neusass (DE)

Correspondence Address: COHEN, PONTANI, LIEBERMAN & PAVANE, 551 FIFTH AVENUE, SUITE 1210, NEW YORK, NY, 10176, US

(73) Assignee: MAN Roland Druckmaschinen AG

(21) Appl. No.: 11/356,840

(22) Filed: Feb. 17, 2006

(30) Foreign Application Priority Data
Feb. 18, 2005 (DE) 10 2005 007 418.9

(51) Int. Cl. B26D 1/00

(52) U.S. Cl. 83/13

(57) ABSTRACT

A method for cross-cutting a printing material web includes placing a cutting knife edge of a cutting knife on the printing material web to be cut and moving the knife edge through the printing material web. The cutting knife edge runs obliquely with respect to the printing material web.

### BACKGROUND OF THE INVENTION

The invention relates to a cutting device and method for cross-cutting a printing material web in which a cutting knife edge of a cutting knife is placed on the printing material web to be cut and moved through the printing material web.

Folders of presses are used to form folds on printed printing materials. According to the prior art, a web-like printing material is first led through what is known as a folding former to form a longitudinal fold on the web-like and not yet severed printing material. Starting from a folding former, the web-like printing material is transported over a plurality of pull rolls in the direction of a cutting knife cylinder and a folding blade cylinder interacting with the cutting knife cylinder, copies being divided off from the web-like printing material on the cutting knife cylinder by cross-cutting. The copy divided off from the web-like printing material on the cutting knife cylinder is moved in the direction of the folding jaw cylinder by the folding blade cylinder and is then transferred from the folding blade cylinder to the folding jaw cylinder, forming a cross fold. The present invention relates to the cross-cutting of the web-like printing material.

During the cross-cutting of a web-like printing material, according to the prior art the procedure is such that a cutting knife edge of a cutting knife which runs parallel to the printing material web to be cut is placed on the printing material web and is moved through the latter such that the entire printing material web is severed simultaneously or at once from one lateral edge of the web to an opposite lateral edge. In the process, considerable cutting forces occur, so that a cutting device and the folder in which the cutting device can be used are subjected to a high mechanical loading.

### SUMMARY OF THE INVENTION

An object of the present invention is to provide a method for cross-cutting a printing material web and a cutting device which overcomes the problems of the prior art.

The object is met by a method in which, during cross-cutting, the cutting knife is moved through the printing material web with a cutting knife edge running obliquely with respect to the printing material web.

According to the present invention, the cutting edge is aligned obliquely with respect to a plane of the printing material web and moved through the printing material web in this oblique position, so that continuous severing of the printing material web between the lateral edges thereof is carried out as the cutting knife is moved through the web. In this way, cutting forces which occur and therefore mechanical loading of the cutting knife and folder are considerably reduced. This is important in particular when thick or multi-layer printing material webs have to be severed.

As the cutting knife edge moves through the printing material web, the cutting knife edge preferably runs obliquely with respect to the printing material web such that the cutting knife edge severs the printing material web continuously from one lateral edge of the printing material web to the opposite lateral edge, the cutting knife edge and the printing material web forming an acute angle not greater than 15°.

According to one embodiment of the invention, an opposing strip interacting with the cutting knife edge and belonging to the cutting knife is also set obliquely with respect to the printing material web, such that an angle enclosed by the opposing strip and the cutting knife edge is greater than the angle enclosed by the cutting knife edge and the printing material web.

The cutting device according to the present invention for cross-cutting a printing material web includes at least one cutting knife with a cutting knife edge which can be placed on the printing material web to be cut and can be moved through the latter. The cutting knife edge of the cutting knife is oriented obliquely with respect to the printing material web.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like reference characters denote similar elements throughout the several views:

FIG. 1 is a schematic front view of a cutting knife and a printing material web to be cut illustrating the method known from the prior art for cross-cutting a printing material web;

FIG. 2 is a schematic front view of a cutting knife and a printing material web to be cut illustrating the method according to the present invention for cross-cutting a printing material web;

FIG. 3 depicts three successive views of the cutting knife and printing material web to be cut of FIG. 2 during a cutting step according to the method of the present invention for cross-cutting a printing material web;

FIG. 4 is a schematic front view of a cutting knife together with an opposing strip of the same according to an embodiment of the present invention; and

FIG. 5 is a graph comparing the cutting forces occurring in the method according to the present invention with the cutting forces occurring in the method known from the prior art.

### DETAILED DESCRIPTION OF THE PRESENTLY PREFERRED EMBODIMENTS

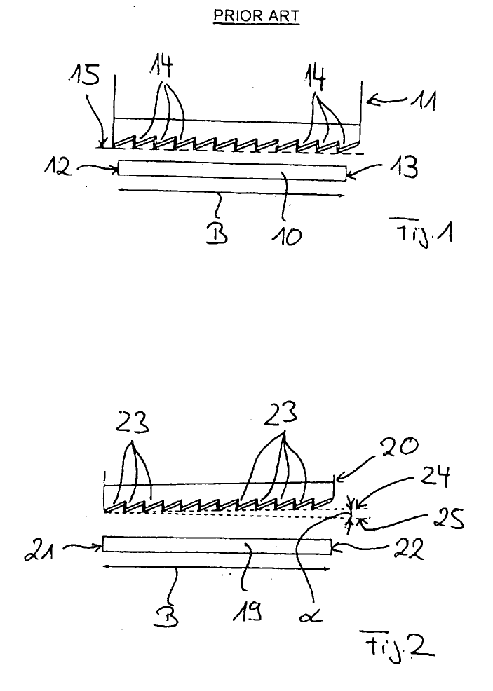

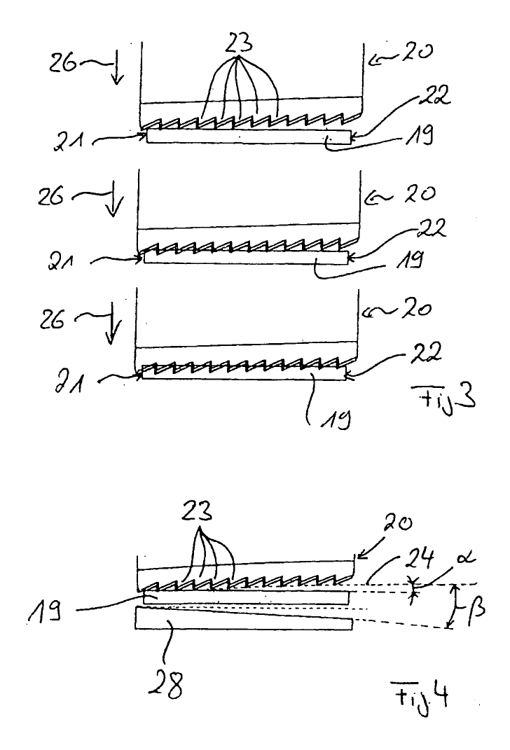

Before the present invention is subsequently described in more detail with reference to FIGS. 2 and 5, the method known from the prior art for cross-cutting a printing material web will be described with reference to FIG. 1.

FIG. 1 illustrates the procedure known from the prior art for cross-cutting a printing material web 10 of width B which, with the aid of a cutting knife 11, is to be severed between a first lateral edge 12 and an opposite lateral edge 13. The cutting knife 11 has a plurality of cutting teeth 14 which define a cutting knife edge 15. According to the prior art, the cutting knife edge 15 runs parallel to a plane of the printing material web 10 to be severed so that, when the cutting knife 11 is moved with the cutting knife edge 15 through the printing material web 10, the printing material web 10 is severed in one step or at once over the entire width B. In this case, high cutting forces occur, which lead to high mechanical loading of a cutting device and a folder in which the cutting device is used. For example, FIG. 5 shows, with the curve 16, the cutting forces which arise when the method known from the prior art according to FIG. 1 is used to cut a printing material web between a rotating cutting knife cylinder and a likewise rotating folding blade cylinder of a folder. In this case, the angular rotation of the cutting knife cylinder is plotted on the horizontal axis 17, and the cuffing force is plotted on the vertical axis 18. It follows directly from FIG. 5 that, when the method known from the prior art according to FIG. 1 is used, very high, pulse-like cutting forces occur.

FIG. 2 shows the positions of a cutting knife 20 and a printing material web 19 illustrating the procedure for cross-cutting the printing material web 19 according to the present invention. The printing material web 19 of FIG. 2 has a width B and, with the aid of a cutting knife 20, is required to be cut from a first lateral edge 21 to an opposite lateral edge 22. The cutting knife 20 has a plurality of cutting teeth 23, which define a cutting knife edge 24. For the purpose of cross-cutting, the cutting knife 20 is moved through the printing material web 19 with a cutting knife edge 24 running obliquely with respect to a plane of the printing material web 19. It can be gathered from FIG. 2 that the cutting knife edge 24 deviates from a line 25 running parallel to the printing material web 19 and forms an acute angle α with the said line and therefore with the printing material web. This angle α is at most 15°, preferably at most 10°.

To sever the printing material web 19, the cutting knife 20 is moved through the printing material web 19 in a direction running approximately at right angles to the latter in the direction of the arrow 26 (see FIG. 3), in such a way that the angle α between the cutting knife edge 24 and the printing material web 19 remains approximately unchanged. As the cutting knife edge 24 moves through the printing material web 19, the printing material web 19 is severed continuously from the lateral edge 21 to the opposite lateral edge 22 which means that the effective cutting knife length is reduced and the cutting forces that occur are reduced relative to the prior art. As a result of the present invention, the cutting phase is lengthened relative to the prior art, the pulse-like rise in the cutting force effective in accordance with the prior art (see curve 16 according to FIG. 5) is prevented, and the maximum cutting force is reduced. Thus, FIG. 5 shows with the curve 27 the cutting forces which occur when a printing material web is severed between a cutting knife cylinder and a folding blade cylinder of a folder by using the method according to the present invention. It can be gathered directly from FIG. 5 that, with the method according to the invention (see curve 27), the cutting forces can be reduced considerably as compared with the prior art (see curve 16).

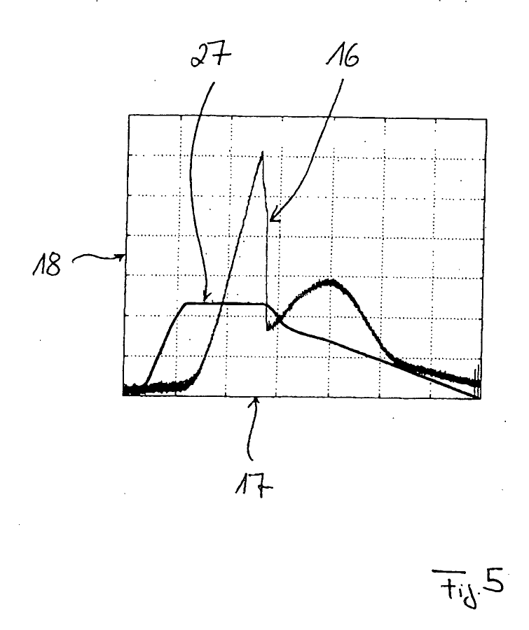

According to an embodiment of the present invention, in addition to the cutting knife edge 24 of the cutting knife 20, an opposing strip 28 interacting with the cutting knife edge 24 and belonging to a corresponding cutting device is additionally set obliquely relative to the printing material web 19. This embodiment is shown in FIG. 4.

In this embodiment, the cutting knife edge 24 and the opposing strip 28 are set obliquely and in opposite directions relative to the printing material web 19 such that an angle β enclosed by the opposing strip 28 and the cutting knife edge 24 is greater than an angle α enclosed by the cutting knife edge 24 and the printing material web 19. In this way, the difference between the circumferential speeds of cutting knife cylinder and folding blade cylinder of a folder can be kept as low as possible. The opposing strip 28 interacting with the cutting edge 24 of the cutting knife 20 is also designated a Vulkolan strip.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for cross-cutting a printing material web, comprising the steps of:
placing a cutting knife edge of a cutting knife on the printing material web to be cut;
moving the cutting knife through the printing material web to be cut for cutting the printing material web, wherein the cutting knife is moved through the printing material web so that the cuffing knife edge runs obliquely with respect to a line parallel to a plane of the printing material web.

2. The method of claim 1, wherein the printing material web has two lateral edges, said step of moving comprises moving the cutting knife edge such that the cutting knife edge severs the printing material web continuously from one of the lateral edges to the opposite one of the lateral edges.

3. The method of claim 1, wherein the cutting knife edge and the line parallel to the printing material web form an acute angle (α) not greater than 15° as the cutting knife edge moves through the printing material web.

4. The method of claim 1, wherein said step of moving comprises moving said cutting knife through the printing material web in a direction running approximately normal to the printing material web such that an angle (α) between the cutting knife edge and the printing material web remains approximately unchanged during said cutting.

5. The method of claim 1, wherein the cutting knife interacts with an opposing strip belonging to a corresponding cutting device, said method further comprising the step of setting the opposing strip obliquely with respect to the printing material web.

6. The method of claim 5, wherein the opposing strip and the cutting knife edge are set obliquely and in opposite directions such that an angle (β) enclosed by the opposing strip and the cutting knife edge is greater than an angle (α) enclosed by the cutting knife edge and the printing material web.

7. The method according to claims 1, further comprising the step of using the cutting knife to sever the printing material web when the printing material web is arranged between a cutting knife cylinder and a folding blade cylinder of a folder.

8. A cutting device for cross-cutting a printing material web, comprising at least one cutting knife having a cutting knife edge arranged and dimensioned so that said knife edge is movable through the printing material to be cut, wherein said cutting knife edge of said cutting knife is oriented obliquely with respect to a line parallel with a plane of the printing material web.

9. The cutting device of claim 8, wherein said cutting knife edge runs obliquely with respect to the line parallel with the printing material web such that said cutting knife edge severs the printing material web continuously from one lateral edge of said material web to the opposite lateral edge of said material web.

10. The cutting device of claim 8, wherein said cutting knife edge runs obliquely with respect to the printing material web such that said cutting knife edge and the line parallel with the printing material web form an acute angle (α) not greater than 15°.

11. The cutting device of claim 8, further comprising an opposing strip interacting with said cutting knife edge, said opposing strip being oriented obliquely with respect to the printing material web.

12. The cutting device of claim 11, wherein said opposing strip and said cutting knife edge are set obliquely such that an angle (β) enclosed by said opposing strip and said cutting knife edge is greater than an angle (α) enclosed by said cutting knife edge and said printing material web.

13. The cutting device of claim 8, wherein said cutting device is part of a folder of a press.
